(19) United States
(12) Patent Application Publication
(10) Pub. No.: US 2017/0200542 A1
(43) Pub. Date: Jul. 13, 2017

(54) Method of Using Hand-Modes to Charge or Energize Materials

(71) Applicant: Seth J. Hornack, New Kensington, PA (US)

(72) Inventor: Seth J. Hornack, New Kensington, PA (US)

(21) Appl. No.: 15/402,916

(22) Filed: Jan. 10, 2017

Related U.S. Application Data
(60) Provisional application No. 62/276,928, filed on Jan. 10, 2016.

(51) Int. Cl. H01F 7/02

(52) U.S. Cl. CPC H01F 7/0273; H01J 49/20

(57) ABSTRACT

The present invention provides a method including: a magnet, hand-modes made by human hand positioning to generate a charge or vibrational frequency, and a material for the hand-mode's charge to be transferred into. The charged material is then used to charge other materials using a magnet, the charged material, and the new material to be charged.

### CROSS REFERENCE TO RELATED APPLICATION

This is a perfection of U.S. Provisional Application No. 62/276,928, filed on Jan. 10, 2016, the disclosure of which is fully incorporated by reference herein.

### BACKGROUND OF THE INVENTION

This invention relates to a method for charging a material using hand-modes and magnetics. The charged material from the hand-mode can then be used to charge or energize other materials.

It is common knowledge, that all materials have specific vibrational frequencies or wavelengths. This common knowledge has been proven using spectrometry often done in a chemistry laboratory class to determine what constitutes an unknown material. This process called mass spectrometry (MS) is defined and consists of an analytical chemistry technique that identifies the type and amount of chemicals existing in a sample by measuring the abundance of gas-phase ions and the mass-to-charge ratio.^{[1]} A plural spectra or mass spectrum is a plot of the ion signal as a function of that mass-to-charge ratio.

The elemental isotopic signature of a sample, or its spectra, is used to determine the masses of molecules and particles and to reveal the chemical structures of molecules, such as chemical compounds or peptides. Mass spectrometry is possible by ionizing chemical compounds to create molecule fragments or charged molecules and measuring their mass-to-charge ratios.

Most often, a mass spectrometry sample is ionized by being bombarded with electrons. The MS sample is usually a gas, liquid, or solid. Such ionization will cause some of a sample's molecules to separate into charged fragments. These charged fragments, or ions, are then divided according to their mass-to-charge ratio usually by subjecting them to an electric or magnetic field while accelerating the ions. Typically, ions of the same mass-to-charge ratio will experience the same amount of deflection and can be identified.^{[1]}

Results of this type of ionization are displayed as spectra of the relative abundance of detected ions as a function of its mass-to-charge ratio. The molecules and atoms in the sample can be recognized by correlating known masses to the identified masses or through a distinctive fragmentation pattern.

Some of the history of spectrometry goes back to 1886 from the work of Eugen Goldstein. Mr. Goldstein witnessed that rays in gas, discharged under low pressure and traveled away from the anode toward the cathode in perforated channels. This was opposite to the direction of negatively charged cathode rays, which travel from cathode to anode. Eugen Goldstein called these positively charged anode rays “Kanalstrahlen”, which translates to “canal rays”.

Then in 1899, Wilhelm Wien found that strong magnetic or electric fields deflect these canal rays. He then constructed a device with parallel magnetic and electric fields in order to separate the positive rays according to their unique charge-to-mass (Q/m). Mr. Wilhelm Wien found that in the discharge tube, the charge-to-mass ratio depended upon the nature of the gas.

J. J. Thomson, an English scientist, improved on the work of Mr. Wilhelm Wien by reducing the pressure in the discharge tube to create the mass spectrograph. Mass spectrometers were also used in the Manhatten Project for uranium enrichment. By 1884, the word spectrograph had become part of the international scientific vocabulary.^{[2] [3]}

Many corporations implement mass spectrometry (MS) using a spectrometer to determine the mineral make-up of a substance.

Several factors allowed Dr. Seth J. Hornack to discover the present invention, also referred to as the Hornack Hand-Mode Process herein. First, the knowledge of spectrometry by realizing that everything has a specific vibrational frequency that was mathematically measurable. Dr. Hornack also realized that the human body always tries to heal itself for survival purposes no matter what the circumstances. For example, why does a cut heal? Why does metal work its way out of the body? Why does the single layer of epithelium lining the trachea thicken to protect itself when exposed to cigarette smoke?

While studying the human body, Dr. Hornack made observations knowing that the hand can mimic any vibrational frequency. For representative hand configurations, see accompanying FIGS. 5, 6 and 7. They are not all-inclusive but merely examples of several hand mode configurations used by the inventor in the energizing of materials hereby. Dr. Hornack observed that humans often put their hands in unique, almost weird, positions throughout the day. He noticed this was especially true for people that were sick or under distress. Dr. Hornack observed this phenomenon in a weight exercise room when an athlete was under serious distress and needed strength. Humans unknowingly put their hands in certain positions (or hand-modes) to generate good wavelengths with their hands and place themselves in a better (if not the best) position for survival. They are actually boosting their own body's energetics naturally.

A small miracle then happened to Dr. Hornack when he was at his mother's house. Denise Hornack had an allergy to raw carrots. Her mouth would tingle, itch, and start to swell when she came into contact with raw carrots. Dr. Hornack had discovered how to use magnetics to help imprint and/or drive vibrations into objects. He asked Denise if she wanted to be part of an experiment. She reluctantly said, “Ok, it's not going to kill me is it?” In the name of science, Dr. Hornack took a raw carrot and transferred the vibrational wavelength into a liquid substance. He then had Denise consume that liquid substance induced with the raw carrot's vibrational frequency. Almost immediately after consuming that substance, Denise exhibited the exact same signs as if she had consumed a raw carrot. Her throat started to tingle, itch, and swell. Then, Dr. Hornack devised various hand-modes to counteract an allergic response using his left hand and induce vibrational hand-modes into a fluid substance. Denise consumed that newly charged substance and immediately her tingling, itchiness, and swelling went away. The inventor had successfully used a hand-mode to induce a vibrational frequency into a substance and the Hornack Hand-Mode Process had begun.

Dr. Hornack has also successfully induced his Hand-Mode Process into water. He conducted experiments visualizing frozen drops of water as they thawed or transitioned from a frozen to an aqueous state (per FIG. 8). He used distilled water for his experiments. Dr. Hornack took distilled water and froze a single drop on petri dishes. He then analyzed the frozen water under a microscope as it transitioned from a frozen state to an aqueous state. The frozen water formed unique crystal lattice configurations (per FIG. 9) when induced with frequencies compared to the control group of distilled water alone, i.e. no frequency inductions (FIG. 8).

Dr. Hornack has also successfully used his Hand-Mode Process to induce hand mode frequencies/charges into a particular material, especially electronics such as cellular telephones, microwaves, computers, other general electronic devices. Test subjects would place a material induced with the Hand-Mode Process onto their electronic device, i.e. a cell phone. In addition, patients whose cell phone had the material induced with the Hand-Mode Process showed an increase in sustained muscle strength compared to those exposed to cellular radiation without the process.

Dr. Hornack has successfully used his Hornack Hand-Mode Process to induce hand mode frequencies into consumable materials like vitamins, minerals, herbs, or vitamin/mineral/herbal supplements. Subjects placed the material induced with the Hand-Mode Process next to their body and cell phones. The subjects using these materials (showed an increase in sustained muscle strength compared to those exposed to cellular, microwave, or computer radiation without using the materials.

### FOOTNOTES

1) Sparkman, O. David (2000). Mass spectrometry desk reference. Pittsburgh: Global View Pub. ISBN 0-9660813-2-3.

2) “Definition of spectrograph.” Merriam Webster. Accessed 13 June 2008.

3) Downard, Kevin (2007). “Historical Account: Francis William Aston: the man behind the mass spectrograph”. European Journal of Mass Spectrometry 13 (1): 177-90. doi:10.1255/ejms.878. ISSN 1356-1049. PMID 17881785.

### SUMMARY OF THE INVENTION

In accordance herewith, the present invention discloses a method to induce a charge or vibrational frequency into a substance. The method requires a magnet, a human hand-mode configured to purposefully induce a desired charge or vibrational frequency, and a material to receive that charge or vibrational frequency. The method entails layering the magnet in a preferred direction, exercising the hand-mode there over, and the product to be induced with the charge or vibrational frequency. The material that was energized with the hand mode can then be used to energize or charge other materials.

The method of the present invention includes uses in chips, containers or cases for electronic devices, cell phones, vitamins, minerals, consumables, non-consumables, water, agriculture, athletic performance enhancement, allergy buffering products, pet products, pet food, jewelry, make-up, toothpaste, toiletries, clothing, human food, beverages, bottles and other household goods.

### BRIEF DESCRIPTION OF THE DRAWINGS

FIG. 1 schematically shows how a material (1c) is charged by a human hand mode (1b) over a magnet (1a) to drive a purposeful charge into that material;

FIG. 2 schematically shows how to take a first material (1c) charged via the hand-mode from FIG. 1 to drive/transfer a charge into a second material (10c);

FIG. 3 shows how to take a material previously charged by the hand-mode from FIG. 1 to drive a charge into consumable products (16c) like vitamins, minerals, herbs, bottles, cans and labels;

FIG. 4 shows how to take a material previously charged to drive/transfer that charge into any of the representative non-consumable materials listed therein;

FIG. 5 is a perspective view of a first representative hand-mode position according to the invention;

FIG. 6 is a perspective view of a second representative hand-mode position;

FIG. 7 is a perspective view of a third representative hand-mode position;

FIG. 8 is a photograph of microscopic distilled water that has been frozen; and

FIG. 9 is a photograph of distilled water (at the same magnification as FIG. 8) showing the unique crystal lattice configurations that were observed as these particle induced with frequencies per the invention transitioned from a frozen to an aqueous state.

### DETAILED DESCRIPTION OF PREFERRED EMBODIMENTS

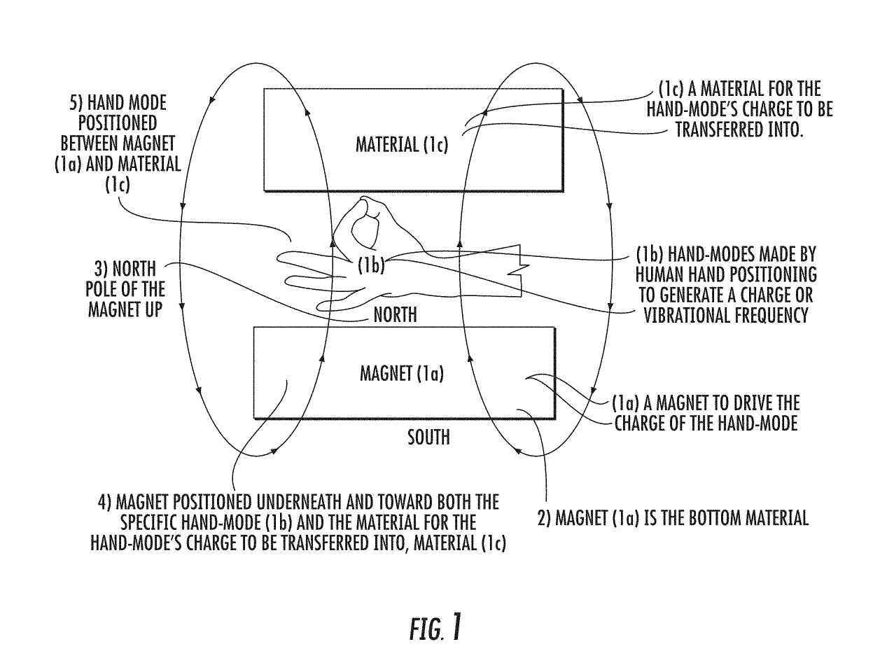

Referring to FIG. 1, an individual takes a magnet and places it with the north pole of the magnet facing upward. He/she then puts their hand in a detailed position to generate a specific charge, Hand-Mode Position (1b), for the intended purpose of applying a charge. The human takes their hand held in the required Position (1b) and places it over the north pole of magnet (1a). The material to be charged (1c) is then placed over both the hand mode (1b) and the magnet's north pole for a minimum of at least 5 seconds. The material (1c) now carries the vibrational charge of the hand mode and becomes a hand-mode charged material.

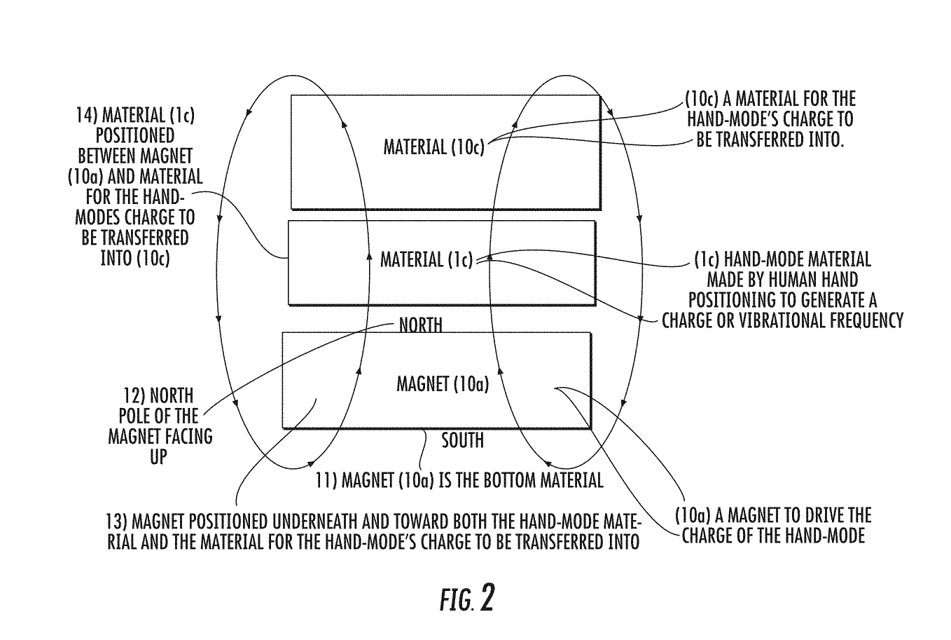

In FIG. 2, magnet (10a) is placed with its north pole facing upward. The previously charged hand-mode material (1c) from FIG. 1 is then placed atop the north pole with a new material to be charged (10c) placed over previously charged material (1c) and magnet (10a). The new (or second) material (10c) is left atop the previously charged material (1c) for at least 5 seconds. That new material (10c) now carries with it the vibrational charge from the original hand-mode (1b) of FIG. 1.

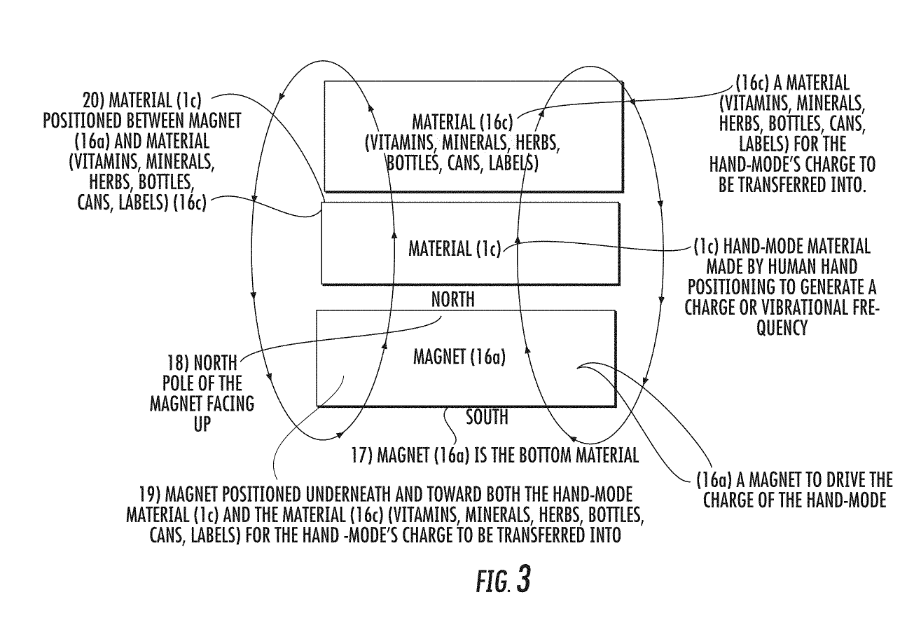

Referring to FIG. 3, a magnet (16a) is placed with its north pole facing upward. A previously charged hand-mode material (1c) from FIG. 1 is then placed over the north pole of magnet (16a). A consumable material (16c) is placed over the previously charged hand-mode material (1c) and north pole of magnet (16a) for at least 5 seconds. That consumable material (16c) now carries with it the vibrational charge of original hand-mode (1b) from FIG. 1.

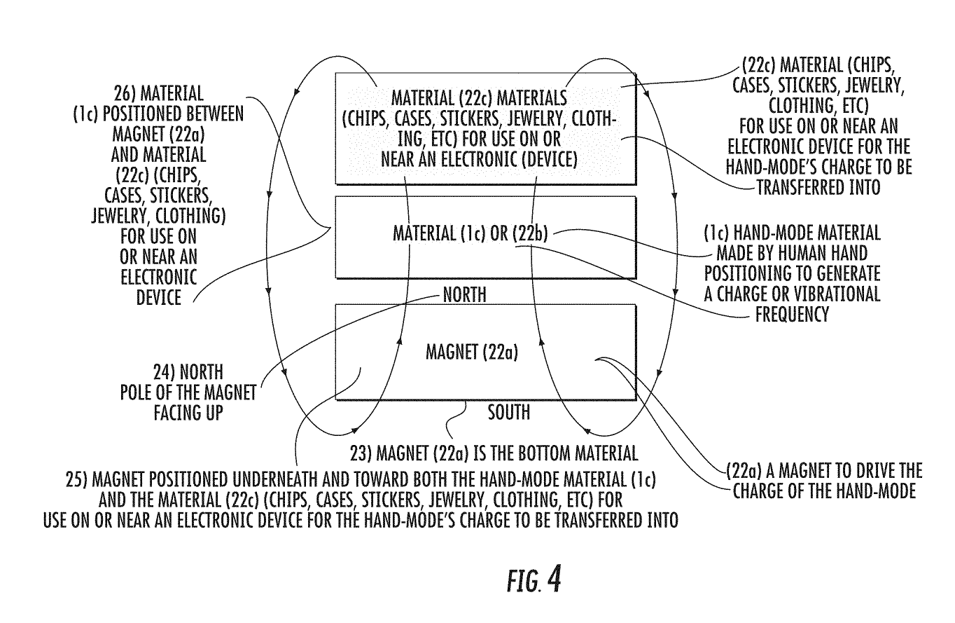

Per FIG. 4, a magnet (22a) is placed with its north pole facing upward. A previously charged hand-mode material (1c) from FIG. 1 is then placed above the north pole of magnet (22a). A non-consumable material (22c) (such as chips, containers, cases, stickers, jewelry, clothing, etc.) is then placed over the previously charged hand-mode material (1c) and the magnet's north pole for at least 5 seconds. That new material (22c) now carries with it the vibrational charge of original hand-mode (1b) from FIG. 1.

Generally speaking, this invention addresses a method of charging a material using a hand-mode like that shown in accompanying FIG. 1. This method requires a magnet to drive the charge of the hand-mode, and particular human hand positioning to generate a charge or vibrational frequency for the item (material) into which the hand-mode's charge will be transferred. For the aforementioned, that magnet may be positioned on the bottom layer of the process, with the magnet's north pole facing up. Alternately, that same magnet may be positioned underneath and toward both the specific hand-mode as well as the material into which the charge will be transferred.

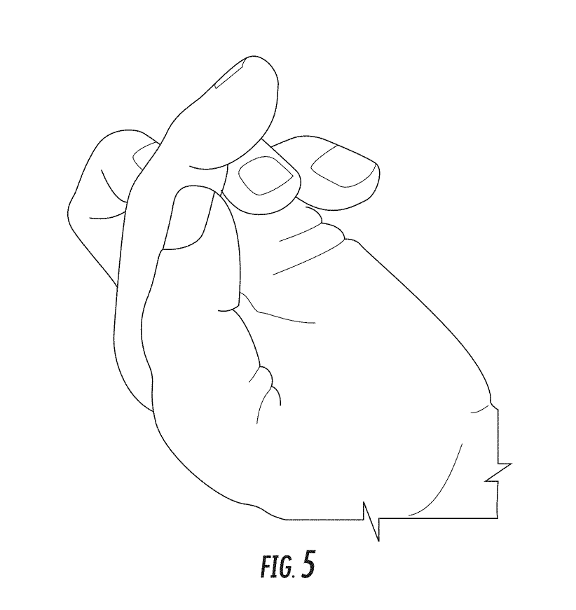

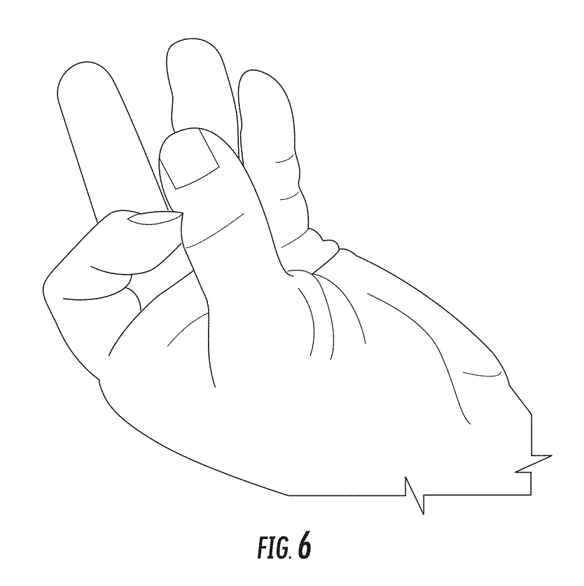

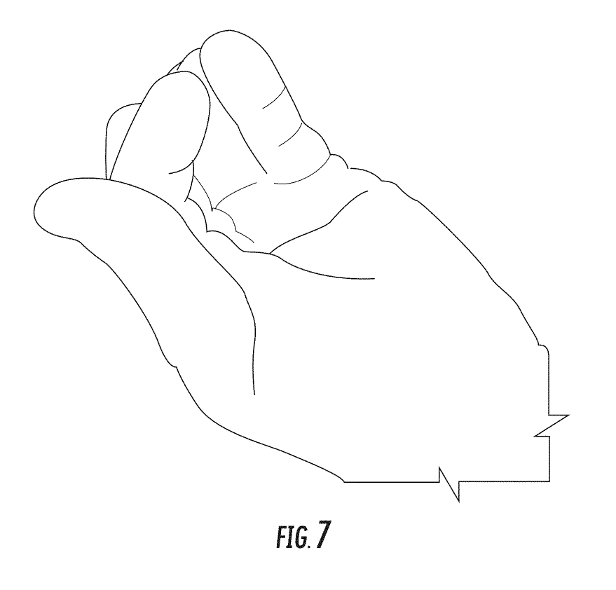

In another embodiment, the preferred hand-mode would be positioned between the magnet and the material to be charged. Representative hand mode positions include those shown in FIG. 5 through 7. Such positioning will generate a specific charge or specific vibrational frequencies. The materials into which energies can be transferred include: metal, like aluminum, a non-metal, plastics/polymers, rubber, meta-materials, ceramics, composites, vitamins, minerals, precious stones, water, organic, inorganic, electronics/optical, consumables, non-consumables, animal products, agricultural and/or pharmaceutical products.

One preferred application of this method is suitable for adding a charge to vitamins, minerals, herbs, or vitamin/mineral/herbal supplement bottles, vitamin/mineral/herbal supplements in containers/cans or in small batch applications. For these approaches, the magnet may be situated on the bottom layer of the materials to be charged, with its north pole facing up, or with the materials being positioned between the magnet and the energy applying hand mode.

For another alternative, the foregoing method of charging may be applied to chips, cases, stickers, jewelry, clothing, etc. More particularly, this method may be used to add charges to:

make-up, electronic devices, cell phones, television or television equipment, computers, cell phone chips, sporting equipment, shoes, furniture, cars, radios, radio equipment, air planes, air plane material, material used for space travel or it's uses, printers, copiers, electrical outlets, cell phone towers, mattresses, pillows, desks, chairs, baby cribs, baby mattresses, shower heads, faucets of sinks, water dispersion equipment, shampoos, soaps, conditioners, body products, containers, lids, caps, pens, pencils, eating utensils, kitchen products, cans, agricultural products, home products, counter tops, bathroom materials, building materials, pet products, or any non-consumable item).

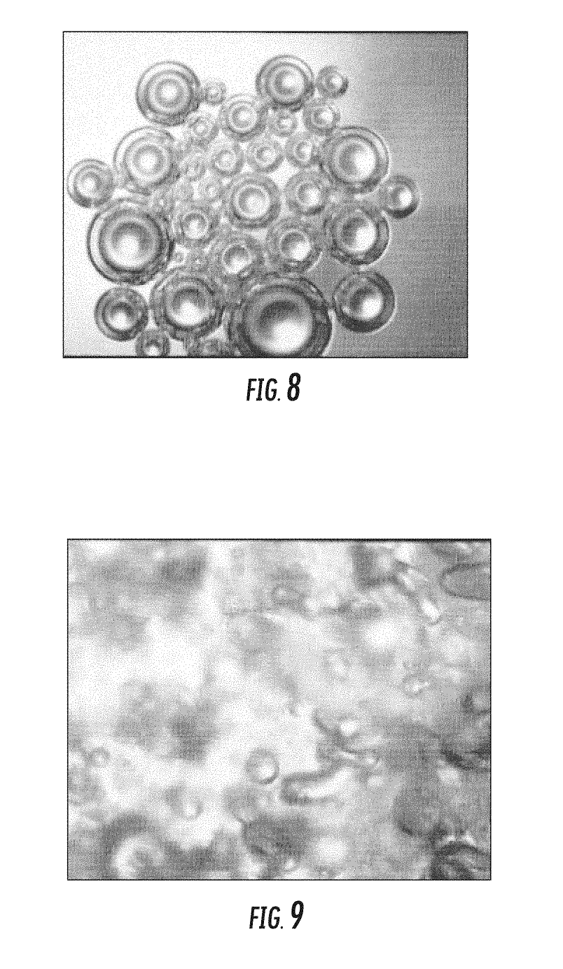

In another instance, practice of this method on distilled water was shown to have a positive effect. It helped form unique crystal lattice configurations when frozen. In accompanying FIGS. 8 and 9, the effects of such charging was observed as the charged, frozen distilled water was analyzed under a microscope as it thawed as compared to a control group that used distilled water with no induced frequencies.

When the object to be charged is a non-consumable and of metallic nature, it is believed that such energizing resulted in an increase in sustained strength on cell phones when exposed to such cellular radiation as compared to a control group that was exposed to cellular radiation but used no materials charged with The Hornack Hand-Mode Process next to their cell phones. For individuals, patients, subjects showed an increase in sustained muscle strength, especially when exposed to cellular, microwave, or computer radiation, when comparing use of the Hornack Hand-Mode Process material next to that person/patient's body.

While the invention has been described in terms of preferred embodiments, the claims appended hereto are intended to encompass all embodiments that fall within the spirit of the invention.

What is claimed is:

1. A method of charging a material comprises:
(a) providing a magnet that can be positioned with its north pole facing upward;
(b) providing the material to be charged by the method, said material being positionable over the north pole of the magnet; and
(b) exercising one or more human hand-mode positions adjacent the material for generating a charge and transferring the generated charge to the material.

2. The method of claim 1 wherein said magnet is positioned on a bottom layer with the material in direct contact with a top of the magnet.

3. The method of claim 1 wherein the hand-mode positions are specially selected for imparting a particular vibrational frequency to the material.

4. The method of claim 1 wherein the hand-mode positions include one or more positions selected from the group depicted in accompanying FIG. 5, 6 or 7.

5. The method of claim 1 wherein the material is a metal chip or coin.

6. The method of claim 1, which further comprises:
(d) positioning the charged material adjacent an electronic device for transferring its charge to the electronic device.

7. The method of claim 6 wherein the electronic device is selected from the group consisting of a cell phone, a laptop computer, and a battery-powered tool.

8. The method of claim 1 which further comprises:
(d) positioning the charged material adjacent a consumable product for transferring its charge to the consumable product.

9. The method of claim 8 wherein the consumable product is selected from the group consisting of a human food product, an animal food product and an agricultural product.

10. The method of claim 8 wherein the consumable product is a pharmaceutical product.

11. The method of claim 8 wherein the pharmaceutical product is selected from the group consisting of a vitamin, a mineral, an herb and a dietary supplement.

12. The method of claim 8 wherein the pharmaceutical product is charged while in a container positioned over the magnet.

13. The method of claim 1 wherein the material is a non-metal product selected from the group consisting of a plastic, a polymer, rubber, a ceramic, a composite.

14. The method of claim 1 wherein the material is bottled water.

15. A method of charging a consumable product comprising:
(a) providing a magnet that can be positioned with its north pole facing upward;
(b) providing the consumable product in a container that is capable of being charged by the method, said container being positionable over the north pole of the magnet; and
(c) exercising one or more human hand-mode positions adjacent the container for generating a charge and transferring the generated charge to the consumable product.

16. The method of claim 15 wherein the consumable product is a pharmaceutical product.

17. The method of claim 16 wherein the pharmaceutical product is selected from the group consisting of a vitamin, a mineral, an herb and a dietary supplement.

18. A method of charging a metal chip comprising:
(a) providing a magnet that can be positioned with its north pole facing upward;
(b) providing the metal chip that is capable of being charged by the method, said metal chip being positionable over the north pole of the magnet; and
(c) exercising one or more human hand-mode positions adjacent the metal chip for generating a charge and transferring the generated charge to the metal chip.

19. The method of claim 18, which further comprises:
(d) positioning the charged metal chip adjacent an electronic device for transferring its charge to the electronic device.

20. The method of claim 19 wherein the electronic device is selected from the group consisting of a cell phone, a laptop computer, and a battery-powered tool.
